(19) United States
(12) Patent Application Publication
(10) Pub. No.: US 2024/0086506 A1
(43) Pub. Date: Mar. 14, 2024

(54) AUTHENTICATION USING TEMPORAL CHARACTERS

(71) Applicant: INTERNATIONAL BUSINESS MACHINES CORPORATION, ARMONK, NY (US)

(72) Inventors: Uri Kartoun, Cambridge, MA (US); Arthi Ireddy, Cary, NC (US); Sophie Batchelder, Cambridge, MA (US); Hannah Justine Mascioli, Pittsburgh, PA (US)

(21) Appl. No.: 17/930,498

(22) Filed: Sep. 8, 2022

(51) Int. Cl. G06F 21/32; G06F 21/45

(52) U.S. Cl. CPC G06F 21/32; G06F 21/45

(57) ABSTRACT

A method, computer system, and a computer program product is provided for authenticating a user. In one embodiment, a method that selects a selecting a username associated with a user. A plurality of characters are provided to be selected and a set of typing styles relating to at least one of these characters are selected to create a password for the user. Subsequently, the username and the password are stored in a database. The password includes the typing styles. The user can then access a resource through authentication by providing a username and password that includes the selected typing styles. The stored username and password is retrieved from the database and checked against user provided information and the user is authenticated when the user provided information and retrieved information are a match.

### BACKGROUND

The present invention relates generally to the field of information security and more particularly to techniques for authentication using temporal characters.

Data protection may be the process of securing digital information while keeping data usable. To provide adequate data protection, intricate authentication methods and processes have been established to protect digital data and privacy. Authentication may be referred as a key to open a digital lock in some sense. It may be a process of proving that the person accessing the data has authority to do so. Authentication processes have become more intricate as fraudulent activities have expanded and become more sophisticated.

The use of textual usernames and passwords may be the most common method to provide authentication. However, most authentication mechanisms of typing a set of characters such as a password do not consider additional aspects such as considering the difference in time between each typed character, as well as considering the use of 2 or more characters concurrently (i.e., a certain password that may be typed in a few seconds has the same effect as if the same password was typed much slower). Incorporating such additional aspects into existing textual-based authentication mechanisms may be expected to significantly enhance security of a variety of resources, including as examples, personal computational devices, web-sites, ATM machines, and databases.

### SUMMARY

Embodiments of the present invention disclose a method, computer system, and a computer program product for authenticating a user. In one embodiment, a method that selects a selecting a username associated with a user. A plurality of characters are provided to be selected and a set of typing styles relating to at least one of these characters are selected to create a password for the user. Subsequently, the username and the password are stored in a database. The password includes the typing styles. The user can then access a resource through authentication by providing a username and password that includes the selected typing styles. The stored username and password is retrieved from the database and checked against user provided information and the user is authenticated when the user provided information and retrieved information are a match.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for generating an authentication technique for any given series of characters according to an alternate embodiment; and

FIG. 3 provides an operational flowchart for generating an authentication technique for a user configured series of characters according to an embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

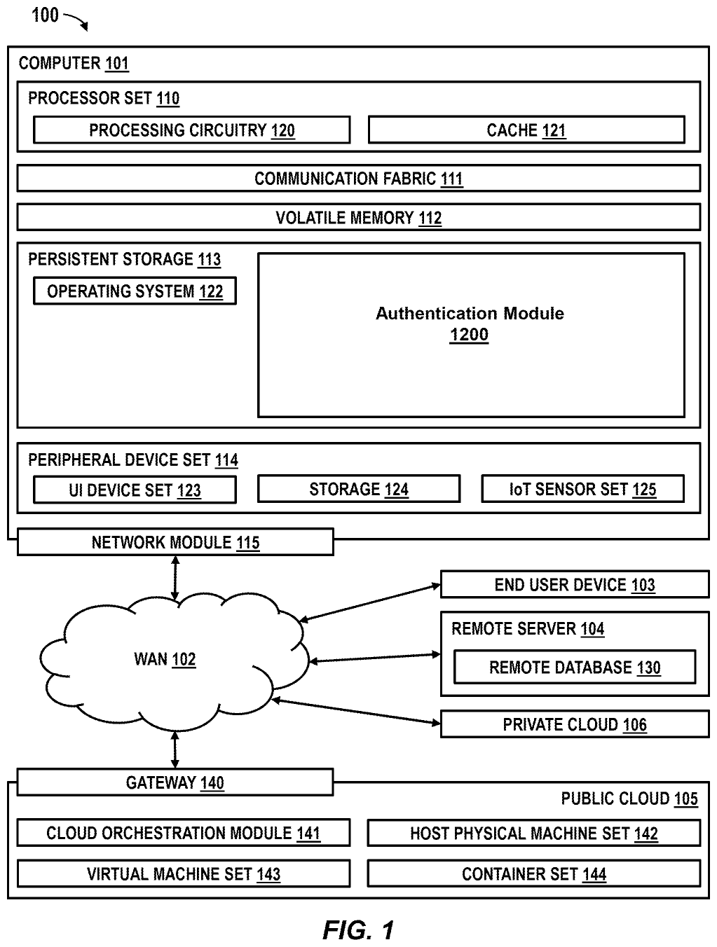

FIG. 1 provides a block diagram of a computing environment 100. The computing environment 100 contains an example of an environment for the execution of at least some of the computer code involved in performing the inventive methods, such as code change differentiator which is capable of providing an authentication module (1200). In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

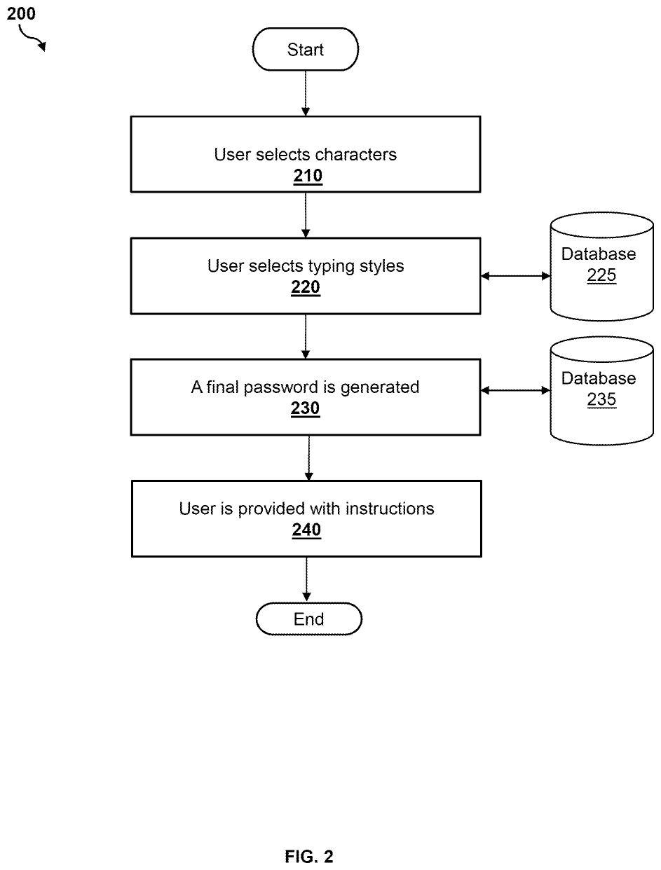

FIG. 2 provides a flowchart depiction of a process 200 that can provide an improved authentication technique. The authentication process 200 provides password creation using temporal characters.

In Step 210, a plurality of characters may be selected to create a password. The characters may be generated by a module or Artificial Intelligence (AI) agents or the like. In one embodiment, when the user may be not picking the characters, the characters may be randomly generated based on a pre-defined series of characters (based on a policy or rule). They may be presented to the user or provided automatically. In another embodiment, the characters may be selected in a unique style of typing (as will be further discussed in Step 220) that may be either similar to user's style or otherwise based on other rules or authentication.

In Step 220, in one embodiment, a set of typing styles are provided that can be used further for use in establishing at least one character in the password. In one embodiment, a typing style generator may be used. In one embodiment, the type styles may be varied and recovered from one or more databases 225. In an alternate embodiment, this could be database 130. The possible styles may include:
1. holding a certain character below a pre-defined time threshold, or,
2. holding a certain character above a pre-defined time threshold, or,
3. holding a certain character for a certain time period between a first and a second time step (timestep1 and timestep2), or,
4. holding two or more characters concurrently (can also follow rules 1-3); or,
5. Other alternative can be also available such as: selecting the character more than once, spacing the characters such as by a time period (between them). The amount of time period may be established by a threshold.

In Step 230, a final password may be generated. In one embodiment, the password and the temporal rules associated with the password may be ultimately stored in one or more databases 235 (or alternatively database 130). In one embodiment, the password to be stored may be:
1. the series of characters, and
2. in the unique style in which the characters were typed (styles relative to the characters).

In one embodiment, both sources of information (1 and 2) required for the successful authentication may be stored in one database. In another embodiment the two sources of information will be stored in different databases, i.e., the series of characters are recorded in database A, and the unique styles in which the characters were typed may be recorded in database B. In another embodiment the series of characters as well as the unique styles may be recorded in more than two databases (e.g., the first half of the characters may be recorded in database A, the second half of the characters may be recorded in database B, 20% of the styles may be recorded in database C, and the rest 80% of the styles may be recorded in database D). The databases, for example, may be linked to the username, and in one embodiment accessible via an additional authentication mechanism (e.g., a text message with a temporary PIN).

In Step 240, the user may be provided instructions presented to use the new password and the user uses the characters associated with the typing styles for future successful authentications.

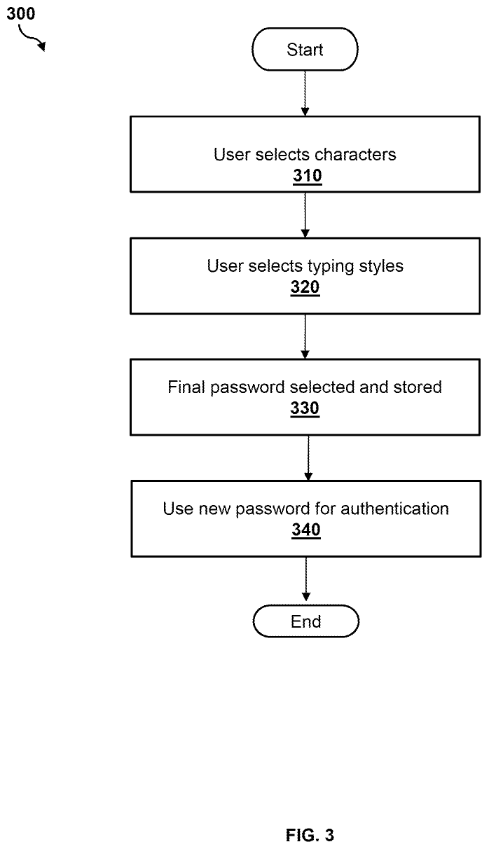

FIG. 3 provides a detailed flow process 300 that discusses how the authentication as discussed in FIG. 2 may be provided for any given series of a scenario that allows a user to configure the characters and create unique typing styles.

As provided in the illustration of FIG. 3, the process may be similar to what was discussed in association with FIG. 2. In Step 310, a user selects a series of characters. In on embodiment, this can be a continuation of the process 200 and process 300 can follow or be simultaneous to Step 240.

In Step 320, a user applies for each one or a subset of series of characters a typing style. As before some of these typing styles may be varied and recovered from a database. The possible styles may include holding a certain character the character less for a pre-defined time threshold or for a certain time period—holding them for a period of time within a window. They may also include holding two or more characters similarly as before. It may also include selecting the character more than once and spaced by a time period between and/or separated by a time period or threshold.

In Step 330, the final password will be stored. This process may be as before and the final password can be stored in a database or a plurality of databases. In one embodiment, the password to be stored may be 1) the series of characters, and 2) in the unique style in which the characters were typed (style relative to the character). Other arrangements can also be possible in alternate embodiments. In one embodiment, each of the sources of information required for the successful authentication may be stored in one database or each in different and varied databases.

Finally, in Step 340 the user uses the characters associated with the typing styles chosen for new password in future successful authentications.

To provide an ease of understanding, some scenarios can be further explored. In a first example, a password generator may be used rather than a user. The password generator suggests to a user a short series of characters (e.g., “btyk”). The generator then specifies to the user as how to type the characters to achieve a stronger and more successful authentication. For example, the generator presents at a user interface:
Hold the first character for least 2 seconds.
Hold both the 2nd and 3rd characters together for less than 1 second.
Wait between 5 and 10 seconds to type the 4th character.

In this scenario, a successful authentication would be achieved only if the user follows the series of characters in a unique typing style proposed by the generator.

In another scenario, there may be no password generator. In this scenario, listener module may be used that asks a user to type a new password in a unique order. For example, the user would:
Type the character “b” and hold it for at east 2 seconds.
Hold both the 2nd and 3rd characters together for less than 1 second.
Wait between 5 and 10 seconds to type the 4th character.
Click “Done”.

In this case, the lister module would record in a database:
1) the series of characters, and
2) the unique style in which the characters were typed.

In one embodiment a successful authentication would be achieved only if the user follows the series of characters in a unique typing style proposed by the generator.

In another embodiment the two sources of information will be stored in different databases, i.e., the series of characters may be recorded in database A, and the unique style in which the characters were typed may be recorded in database B. The databases, for example, may be linked to the username, and in one embodiment accessible via an additional authentication mechanism (e.g., a text message with a temporary PIN).

The techniques used herein, allow users to have to memorize shorter passwords that may be just as strong as longer more intricate ones. Many organizations ask their users to provide complex passwords (e.g., 15+ characters with numbers, capitals and unique characters), Whether geared toward an organization or initiated by the user, the techniques provided allow users to remember only a small number of characters, with the tradeoff of memorizing different time durations, i.e., styles/rules. These techniques may also enhance the existing password mechanism (e.g., add another layer of security for current long and complex passwords). The functionality, as provided in one embodiment, may be used by many different software platforms and companies, including those that develop desktop-based, mobile-based, or alternatively website-based tools. This will allow password include typing characters that may be delayed, password characters that may be temporary, password characters with a type of a timestamp, password characters provided at different times, and password characters types concurrently for a pre-defined time. In one embodiment, for example, to authenticate a user may need to hold a first character for at least 2 seconds, then while holding the first character hold a second character for at least 4 seconds, and while still holding the first and second characters, hold a third character for 2 to 4 seconds. The second character should be held at least 2 seconds after the first character was initially pressed. The third character must be held at least 10 seconds after the first character was held. This mechanism has been inspired by musical instruments such as pianos/synthesizers, in which a user can press and hold 2 or more keys with a variety of variations such as for how long to hold each key, the time difference of holding each key compared to other keys, and the number of keys used (e.g., 2, 3, 5, or more).

Current approaches to multi-factor authentication lack scalability, among other capabilities and efficiencies. The process 200/300 provide for robust and scalable multi-factor authentication using a combination of network-based and device-based authentications. In an example embodiment, a common policy framework enables policy enforcements to be carried out in the network or on the device. As described below, the framework may provide synchronization of policies and authentication results between a network entity and an entity on a user device. This allows for a password with a pattern that, takes time/length of the password for typing characters as part of the authentication (allows a user to set patterns of characters with the option of setting time on each of the characters or the complete pattern). This allows for the authentication to be also completely a customizable experience.

When users get access to different services, the class of services may vary, for example, from low-cost services to high-value services. A low price may indicate that a low authentication strength may be required, while a high price may indicate that a high authentication strength may be required to access the service.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for authentication of a user, comprising:
selecting a username associated with a user;
providing a plurality of characters selected and applying a set of typing styles relating to at least one character selected so as to create a password for said user;
storing said username, and password in a database; wherein said password includes said typing styles;
allowing said user to access a resource by authenticating said user, said authentication including;
providing said username and said password, said password including providing said characters using said selected typing styles; and
retrieving from said database said stored username and password and checking this information to ensure provided username and password are identified correctly, wherein said password match also includes a match between characters and typing styles.

2. The method of claim 1, wherein said typing style includes holding a certain character for a certain amount of time.

3. The method of claim 1, wherein there is a preselected time between a first and a second character, wherein any time less than said preselected time makes the characters to be distinguished as one character and time more than said preselected time make the characters be distinguished as two distinct characters.

4. The method of claim 3, wherein said two or more characters can be identical characters.

5. The method of claim 3, wherein said characters can be selected character more than once and spaced by a time period more or less than said time period.

6. The method of claim 1, wherein said password characters selected by said user are stored and recorded.

7. The method of claim 6, wherein two consecutive characters are to be treated as one when the time entry between them is below a threshold.

8. The method of claim 6, wherein same characters are deemed to be different characters if they are entered for a period above a threshold.

9. The method of claim 6, wherein a new character is recorded with at least two characters are entered simultaneously.

10. The method of claim 1, the username and password are stored in a database.

11. The method of claim 7, wherein the username and password are stored in different databases.

12. A computer system for authenticating a user, comprising;
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps:
selecting a username associated with a user;
providing a plurality of characters selected and applying a set of typing styles relating to at least one character selected so as to create a password for said user;
storing said username, and password in a database; wherein said password includes said typing styles;
allowing said user to access a resource by authenticating said user, said authentication including;
providing said username and said password, said password including providing said characters using said selected typing styles; and
retrieving from said database said stored username and password and checking this information to ensure provided username and password are identified correctly, wherein said password match also includes a match between characters and typing styles.

13. The computer system of claim 12, wherein said typing style includes holding a certain character for a certain amount of time.

14. The computer system of claim 12, wherein there is a preselected time between a first and a second character, wherein any time less than said preselected time makes the characters to be distinguished as one character and time more than said preselected time make the characters be distinguished as two distinct characters.

15. The computer system of claim 12, wherein said password characters selected by said user are stored and recorded.

16. The computer system of claim 15, wherein two consecutive characters are to be treated as one when the time entry between them is below a threshold.

17. The computer system of claim 16, wherein same characters are deemed to be different characters if they are entered for a period above a threshold.

18. The computer system of claim 12, wherein a new character is recorded with at least two characters are entered simultaneously.

19. A computer program product for authenticating a user, comprising:
one or more computer-readable storage medium and program instructions stored on at least one of the one or more tangible storage medium, the program instructions executable by a processor, the program instructions comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps comprising:
selecting a username associated with a user;
providing a plurality of characters selected and applying a set of typing styles relating to at least one character selected so as to create a password for said user;
storing said username, and password in a database; wherein said password includes said typing styles;
allowing said user to access a resource by authenticating said user, said authentication including;
providing said username and said password, said password including providing said characters using said selected typing styles; and
retrieving from said database said stored username and password and checking this information to ensure provided username and password are identified correctly, wherein said password match also includes a match between characters and typing styles.

20. The computer program product of claim 19, wherein said password characters selected by said user are stored and recorded.
